(19) United States
(12) Patent Application Publication
(10) Pub. No.: US 2008/0204988 A1
(43) Pub. Date: Aug. 28, 2008

(54) Jersey display case with flat panel monitor mounting system

(76) Inventor: Joshua Altieri, Oakland, CA (US)

Correspondence Address: Adam Boskovic, 1452 Willard Street, San Francisco, CA, 94117, US

(21) Appl. No.: 12/071,181

(22) Filed: Feb. 19, 2008

Related U.S. Application Data
(60) Provisional application No. 60/902,293, filed on Feb. 20, 2007.

(51) Int. Cl. G06F 1/16

(52) U.S. Cl. 361/681

(57) ABSTRACT

A jersey display case with flat panel monitor mounting system designed for use as a sports memorabilia display. The jersey display case is a square shape, that is 43″ high, 34.5″ wide, and 6″ in depth. The top half of the display case features a jersey display area (25″ high and 34″ wide). The bottom half features the flat panel monitor mounting system, which consists of two components; frame mounting plate and the monitor adaptor plate. The frame mounting plate is bolted into the rear panel and features two vertical brackets. The monitor adaptor plate is attached to the rear of the flat panel monitor via 10 mm or 20 mm screws. The monitor adaptor plate slides into the brackets of the frame mounting plate, thus securing the flat panel monitor into position. The flat panel monitor will be used to display video highlights of the player (whose jersey is being featured in the jersey display case).

### CROSS-REFERENCE TO RELATED APPLICATIONS

The present application claims the benefit of Provisional Patent application Ser. No. 60/902,293 filed originally and only by the inventor, Joshua Altieri, with the United States Patent and Trademark Office and entitled “Jersey Display Case With Flat Panel Monitor Mounting System”.

### BACKGROUND OF THE INVENTION

1. Field of the Invention

The present invention relates to display cases, more specifically to the jersey display cases that feature sports jerseys. This present invention also relates to the various types of television mounting systems, more specifically related to the television mounts that secure and position flat panel monitors.

2. Description of Related Art

There are many jersey display frames and sports memorabilia display cases on the market, these fixtures provide a manner in which sports jerseys can be displayed. For example, the jersey display frame design that includes a sports jersey filled with pads to simulate a three-dimensional view. Additionally, there are many television mounting systems on the market. Basic functional mounts include the standard desktop mount, a basic external frame with base. Other types of mounts include a pole mount, arm mount, or wall mount such as U.S. Pat. No. 7,300,029 to Petrick, et al. (2007), a wall mount that pivots for repair access. There are also mounts that have external decorative coverings such as a basketball or baseball.

There does not exist in the prior art, however, the present invention wherein the jersey of an athlete is displayed together with a mounted flat panel monitor display. The utility of such a combination is to bring together the nostalgic and tangible (the jersey) with the informative and intangible (highlight moments and personal statistics such as batting average, touchdowns, etc.). When displayed in a museum or other facility, the person interacting with the display can immediately associate the player name and number on the jersey with the accomplishments on the monitor.

The utility of the flat panel mounting system within the case becomes clear where only a flat panel type display device could be used with a display case to perform the above utility of the combination. The current mount, while simple, is not found in the prior art because nowhere is such a mount used to affix a flat panel monitor to a display case back. The current mount is specifically designed to have as slim a profile as possible and to be positioned anywhere on the display case back. Wall mounts such as the one to Petrick et al above would not work with a display case back because they would cause the monitor to extend too far out from the display case back while adding considerable unnecessary weight to the display case. The mount to Petrick et al and similar ones would also extend too far out the back of the display case inabling the display case to hang flush to a wall.

### SUMMARY OF THE INVENTION

The present invention relates to a jersey display case. The present invention is a flat panel monitor mounting system inside a jersey display case. The innovative frame mounting system will provide the ability to utilize technology. a spectator will now enjoy the benefit of a multi-media viewing experience when viewing the sports jersey in a display case.

The present invention is four sided and forms into a square shape with a predetermined width and height. All four sides of the exterior frame are connected to the rear panel, the rear panel functions as a spine providing support and maintaining shape of the jersey display case. The mandatory function of the external frame is to provide depth within the jersey display case, the depth is necessary to provide ample room for the frame mounting system. The frame mounting system is constructed with two main pieces; a frame mounting plate and a monitor adaptor plate. The frame mounting plate is bolted into the rear panel and the monitor adaptor plate is attached to the rear of the flat panel monitor. Once the flat panel monitor is secured into the monitor adaptor plate, the monitor adaptor plate hooks into the frame mounting plate brackets. To complete the present invention, screws are fastened through the external frame and into the rear panel.

The following design additions were added to make this present invention commercially viable and to enhance the aesthetic value. The first visual enhancement includes a fabric glued to the top half of the rear panel; this provides an aesthetic platform for the jersey to be featured upon. Then the sports jersey is sewn into the rear panel to provide a permanent impression of a newly pressed jersey. Another visual enhancement is the plastic bottom cover piece, which surrounds the flat panel monitor and covers the remaining space beneath the sports jersey. The bottom cover piece will have two circle shaped holes cut into it to provide space to feature audio speakers.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1 is a perspective view of the jersey display case with flat panel monitor mount incorporating the principles of the present invention:

FIG. 2 is a perspective view of the bottom cover piece:

FIG. 3 is a perspective view of the flat panel monitor affixed to the jersey display case using the frame mounting system of this present invention (Bottom Cover Piece removed):

FIG. 4 is a perspective view of how the external frame is connected to rear panel:

FIG. 5 is a side view of the frame mounting system with flat panel monitor attached via the frame mounting system of this present invention:

FIG. 6 is a side view of how the monitor adaptor plate attaches to the flat panel monitor:

FIG. 7 is a rear view of the monitor adaptor plate attached to the flat panel monitor:

FIG. 8 is a perspective view of the monitor adaptor plate hooked into the frame mounting plate (Flat panel monitor not included):

FIG. 9 is a top plan view of the monitor adaptor plate hooked into the frame mounting plate:

FIG. 10 is a perspective view of how the monitor adaptor plate is removed from the frame mounting plate:

FIG. 11 is a side view of the frame mounting plate:

FIG. 12 is a perspective view of the monitor adaptor plate:

FIG. 13 is a perspective view of the frame mounting plate:

### DETAILED DESCRIPTION

The following is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

The present invention provides a jersey display case with flat panel monitor mounting system. While previously designed jersey display cases do feature certain design enhancements, the fundamental design lacks the ability to incorporate audio and video elements into the visual presentation of the jersey. The main purpose of this present invention is to integrate video and audio elements into the visual presentation of the sports jersey. The frame mounting system provides the platform for the video display (flat panel monitor). And, the bottom cover piece of this present invention provides the outlets for easy display of the audio elements. The flat panel monitor and speakers will be used to display video highlights of the player whose jersey is being featured in the jersey display case.

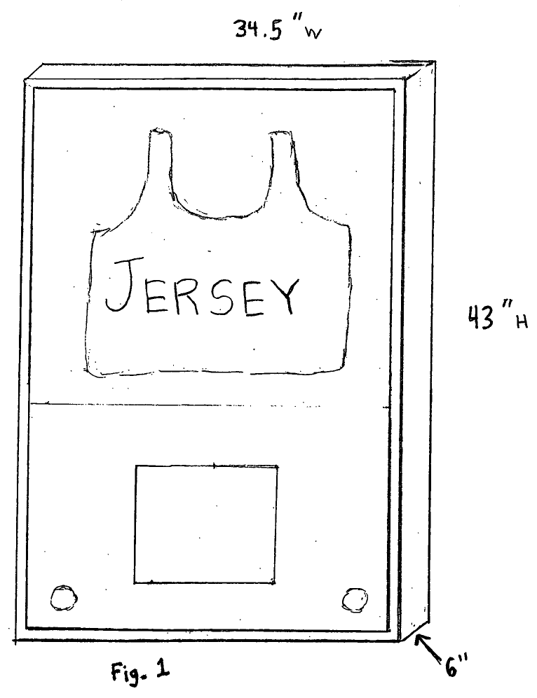

FIG. 1 is a perspective view of the jersey display case. The dimension of the exterior frame of this jersey display case is 34.5″ wide and 43″ high. The exterior frame is built to provide 6″ of depth within the jersey display case. This depth provides space for the flat panel monitor to be securely affixed to the rear panel via the frame mounting system of this present invention. The top half of the rear panel is a flat platform for a jersey to be displayed upon, the dimension for the jersey display area is 34″ wide and 24″ in height. Lastly, the Bottom Cover Piece (B.C.P.) accomplishes two major objectives; to hide the internal components of this present invention and also to provide outlets for the audio speakers. These components will be discussed in further detail in the following illustrations.

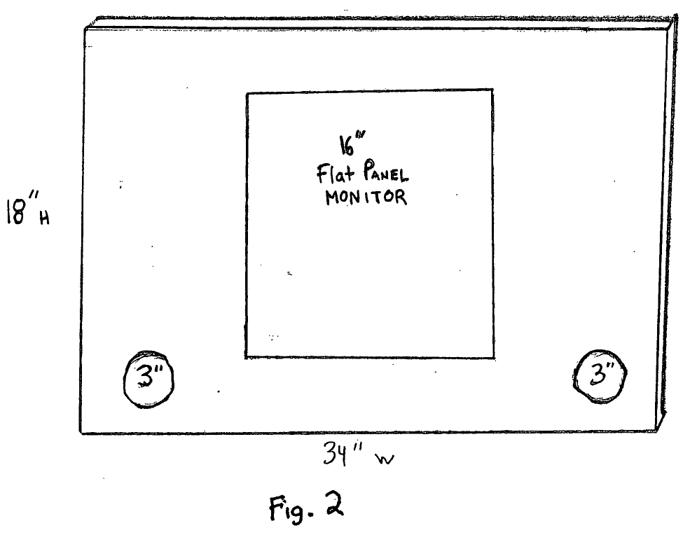

FIG. 2 is a perspective view of the bottom cover piece. The dimensions are 34″ wide and 18″ high. In the bottom left and right corners are two circular shaped holes (roughly 3″ in diameter), these holes provide an outlet for the audio speakers. The B.C.P. also features a square shaped opening which is precisely where a 16″ flat panel monitor is to be displayed via the frame mounting system of this present invention.

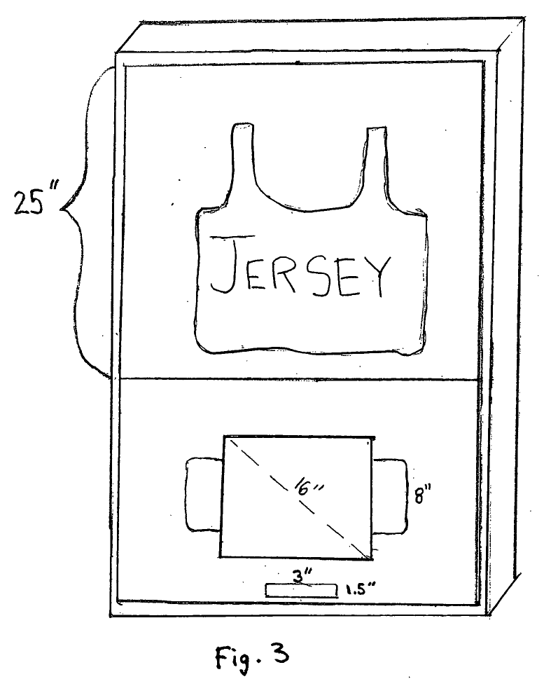

FIG. 3 is a perspective view of the flat panel monitor affixed to the jersey display case using the frame mounting system of this present invention with the Bottom Cover Piece (B.C.P.) removed. Also, in FIG. 3 the top half of the display case features a jersey display area (25″ high and 34″ wide) and details the manner in which the jersey is sewn into the jersey display area. And, since the B.C.P. is removed you can view the bottom opening (3″×1.5″) in the middle of the rear panel, which provides an outlet for electrical adaptors.

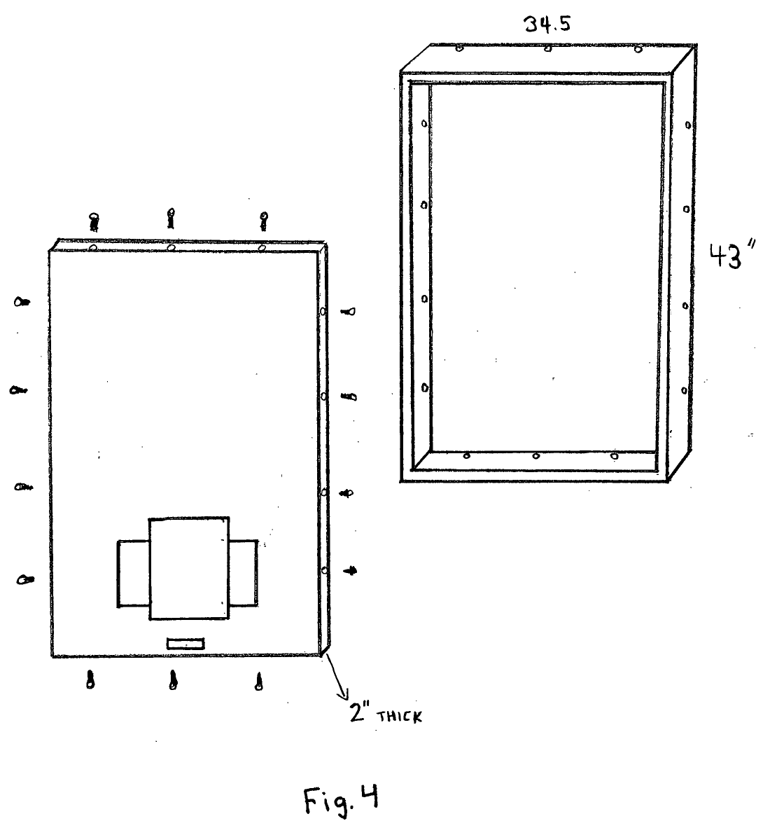

FIG. 4 is a perspective view of how the external frame is connected to the rear panel. The rear panel dimension is 34″ wide, 43″ high and 2″ thick. The external frame is 34.5″ wide, 43″ high, and 6″ thick. The external frame is secured into the rear panel via ¾″ screws. The external frame outer core is composed of plastic. There are 14 different screw holes on the rear panel. To connect the external frame and the rear panel, 14 screws are fastened through the sides, top, and bottom of the external frame into the sides, top, and bottom of the rear panel.

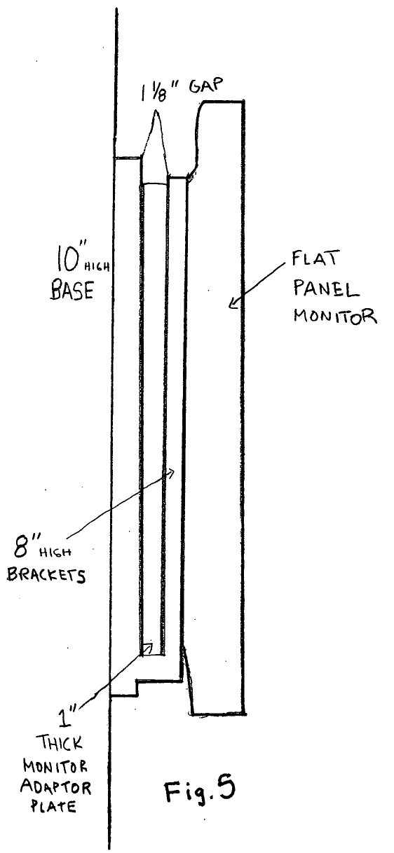

FIG. 5 is a side view of the frame mounting system with flat panel monitor attached via the frame mounting system of this present invention. The base of the frame mounting plate is 10″ high and bolted into the rear panel. The vertical brackets of the frame mounting plate are 8″ high. After the monitor adaptor plate is secured into the flat panel monitor, then the 1″ thick monitor adaptor plate slides in the 1⅛″ gap between the frame mounting plate base and it's vertical brackets.

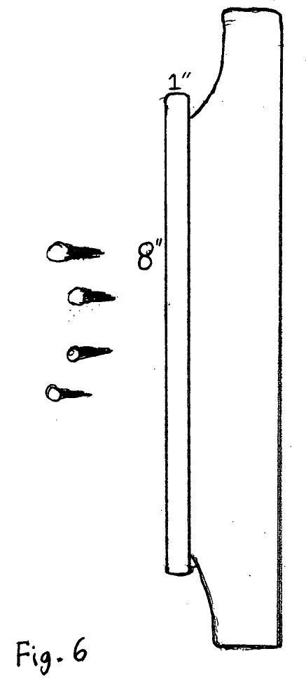

FIG. 6 is a side view of how the monitor adaptor plate attaches to the flat panel monitor. The monitor adaptor plate is 8″ high and 1″ thick. 10 mm or 20 mm screws are fastened through the monitor adaptor plate and tightened into the flat panel monitor. The hole pattern will depend on the flat panel monitor specs, but the monitor adaptor plate can accommodate both the VESA 75″ and VESA 100 mounting patterns.

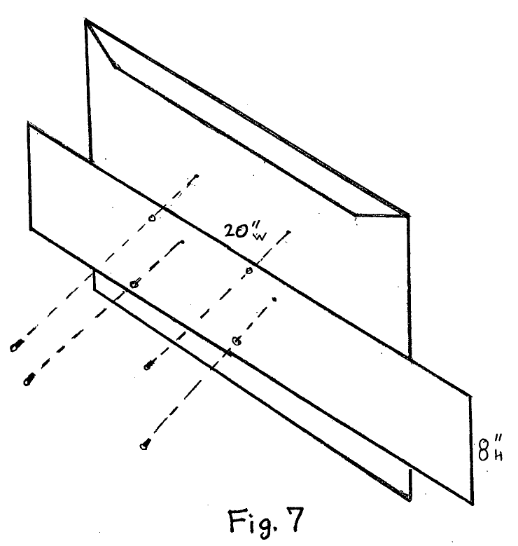

FIG. 7 is a rear view of the monitor adaptor plate attached to the flat panel monitor. The monitor adaptor plate is 20″ wide and 8″ high. The screw holes are contained within the 5″ by 5″ middle section of the frame adaptor plate. Again, either 10 mm or 20 mm screws are used to attach the monitor adaptor plate to the flat panel monitor (Hole pattern depends on monitor specs).

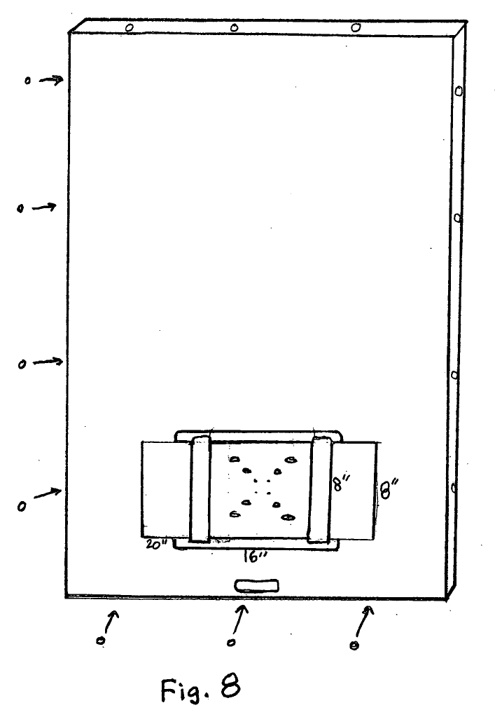

FIG. 8 is a perspective view of the monitor adaptor plate hooked into the frame mounting plate (Flat panel monitor not included). The 1″ thick monitor adaptor plate rests in the 1⅛″ gap that exists between the base of the frame adaptor plate and the vertical brackets of the frame mounting plate. The rear panel is 2″ thick and the screw holes are located every 9″ on the sides and every 10″ on the top and bottom.

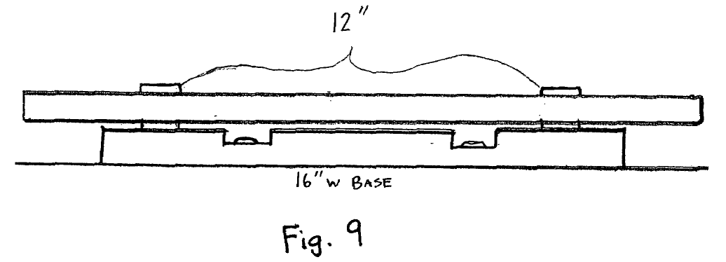

FIG. 9 is a top plan view of the monitor adaptor plate hooked into the frame mounting plate. The bolts of the frame mounting plate are inside the base of the frame mounting plate, so the bolts do not obstruct the monitor adaptor plate from entering the 1 ⅛″ gap between the frame mounting plate base and the brackets.

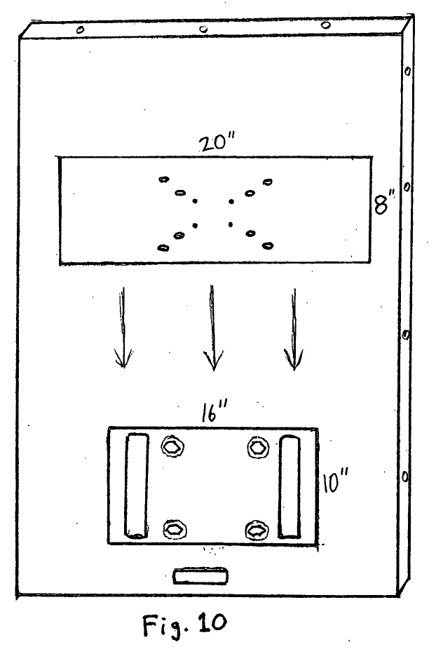

FIG. 10 is a perspective view of how the monitor adaptor plate is removed from the frame mounting plate. The 1-inch thick monitor adaptor plate is lifted from the 1⅛ inch gap between the frame mounting plate base and it's brackets. The height of the monitor adaptor plate and height of the frame mounting plate brackets have the same exact height of 8 inches to provide a secure fit.

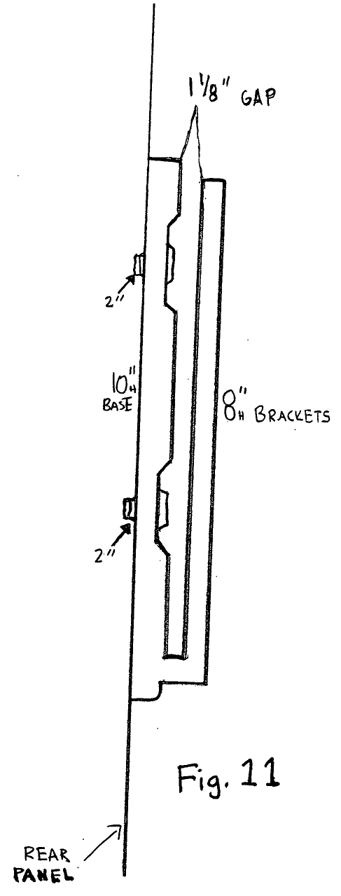

FIG. 11 is a side view of the frame mounting plate. The base is 10″ high and the extended brackets are 8″ high. The four bolts that are located inside the base of the frame mounting plate are 2″ in length and secure into rear panel. There is a 1⅛″ gap between the base and brackets. The brackets of the frame mounting plate are 12″ apart in width.

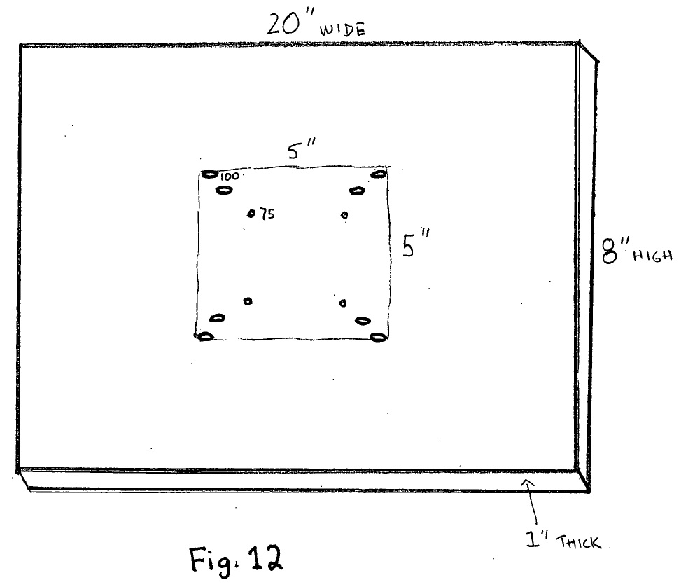

FIG. 12 is a perspective view of the monitor adaptor plate. The dimension of the monitor adaptor plate is 8″ high and 20″ wide and 1″ thick. The monitor adaptor plate features different hole mounting patterns the VESA″ 75 and VESA 100. Both hole mounting patterns fit inside a 5″×5″ middle section on the monitor adaptor plate.

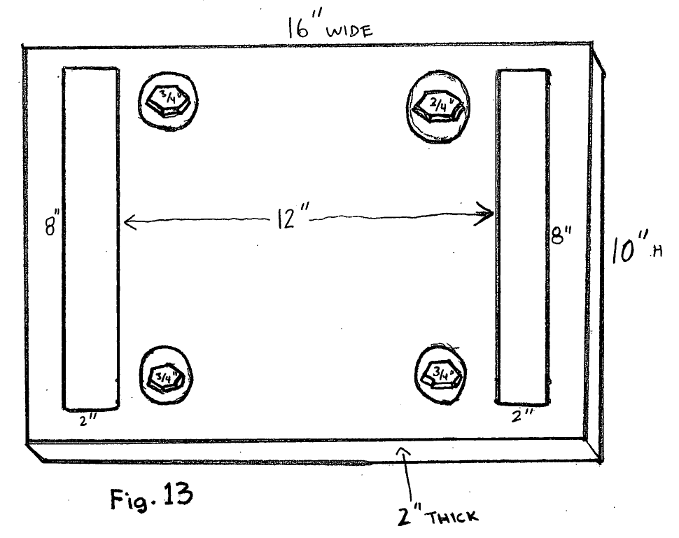

FIG. 13 is a perspective view of the frame mounting plate. The overall shape of the frame mounting plate is square and the dimensions are 16″ wide and 10″ high. The frame mounting plate features two brackets, which extend vertically from the frame mounting plate base at a 90-degree angle. The brackets provide a 1⅛″ inch gap between the frame mounting plate and the brackets. This 1⅛″ gap allows the screen adaptor plate to slide into frame mounting plate, thus securing the screen adaptor plate into the frame mounting system. The frame mounting plate features four bolts; these bolts secure the frame mounting plate into the rear panel.

While the invention has been described with reference to specific embodiments, it will be understood by those skilled in the art that various changes may be made and equivalents may be substituted for elements thereof without departing from the true spirit and scope of the invention. In addition, modifications may be made without departing from the scope of the invention. In addition, modifications may be made without departing from the essential teachings of the invention.

What is claimed is:

1. A display case wherein a flat panel monitor is mounted positionally next to a display item or items affixed within said display case, said display case comprising: a rear panel affixed to the four sides of said display case, and whereby a bracket plate is attached to the inner surface of said rear panel and whereby said bracket plate comprises two parallel L-shaped brackets extending outward and upwards from body of said bracket plate creating two parallel gaps between the inner surface of the upward portion of said L-shaped bracket and the body of said bracket plate and whereby a mounting plate is attached to the rear of said flat panel monitor so that said mounting plate can be slid into said gaps thereby mounting said flat panel monitor to said rear panel of said display case.

2. The display case of claim 1 wherein said mounting plate comprises attachment points that correspond to attachment points on said flat panel monitor so that said mounting plate can be properly affixed to said flat panel monitor.
